(19) United States
(12) Patent Application Publication
(10) Pub. No.: US 2004/0109014 A1
(43) Pub. Date: Jun. 10, 2004

(54) Method and system for displaying superimposed non-rectangular motion-video images in a windows user interface environment

(75) Inventor: Johnathan James Henderson, Cincinnati, OH (US)

Correspondence Address: FROST BROWN TODD LLC, 2200 PNC Center, 201 E. Fifth Street, Cincinnati, OH, 45202-4182, US

(73) Assignee: Rovion LLC

(21) Appl. No.: 10/310,379

(22) Filed: Dec. 5, 2002

(51) Int. Cl. G09G 5/00

(52) U.S. Cl. 345/716

(57) ABSTRACT

Presentation of composited video images onto a digital user interface enables an actor to move independently of the underlying application windows, increasing the dramatic effect and allowing accompanying digital content to be displayed in a complementary fashion. Chroma-key operation on the frames of the video image to detect a foreground portion of each frame provides a robust response to nonuniform background colors or to artifacts introduced during compression and transmission by threshold comparison of a variation of pixels in the frame to an expected or detected background color value.

### CROSS REFERENCE TO RELATED APPLICATIONS

The present application hereby claims the benefit of the provisional patent application of the same title and inventor, Ser. No. ______, filed on Nov. 14, 2002.

### FIELD OF THE INVENTION

The present invention relates to computer streaming video presentation and more specifically relates to superimposing a video stream with an arbitrary shaped display region on a windowing computer interface.

### BACKGROUND OF THE INVENTION

Popular operating systems today support windowing environments. This allows application programs running in the computer to display their visual output and receive input through a rectangular portion of the screen called a window. In windowing systems, the operating system typically displays its own interface called the “shell” in one or more windows. In addition to displaying its interface, the operating systems include graphic support software to allow applications to create and display their own windows.

Streaming video is a sequence of “moving images” that are sent in compressed form over the Internet or local area network and are displayed to the viewer as they arrive. Streaming media is streaming video with sound. With streaming video or streaming media, a computer user does not have to wait to download a large file before seeing the video or hearing the sound. Instead, the media is sent in a continuous stream and is played as it arrives. The user needs a player, which is a special program that uncompresses and sends video data to the display and audio data to speakers. A player can be either an integral part of a browser or be an installed application, most commonly downloaded from the software maker's Web site.

Major streaming video and streaming media technologies include Macromedia Flash, a variety of delivery mechanisms from Sorenson Media Inc., RealSystem G2 from RealNetwork, Microsoft Windows Media Technologies (including its NetShow Services and Theater Server), and VDO. Microsoft's approach uses the standard MPEG compression algorithm for video. The other approaches use proprietary algorithms. (The program that does the compression and decompression is sometimes called the codec.) Microsoft's technology offers streaming audio at up to 96 Kbps and streaming video at up to 8 Mbps (for the NetShow Theater Server). However, for most Web users, the streaming video will be limited to the data rates of the connection (for example, up to 128 Kbps with an ISDN connection). Microsoft's streaming media files are in its Advanced Streaming Format (ASF).

Streaming video is usually sent from prerecorded video files, but can be distributed as part of a live broadcast “feed.” In a live broadcast, the video signal is converted into a compressed digital signal and transmitted from a special Web server that is able to do multicast, sending the same file to multiple users at the same time.

When an application program wishes to show streaming video in a conventional windowing environment, it draws a sequence of rectangular pictures into a rectangular-shaped window. Each picture or “frame” typically consists of one or more non-rectangular objects. The graphical objects in a given frame are typically stored in a bitmap. A bitmap is a digital image comprised of a rectangular array of numbers corresponding to individual picture elements (pixels) on the display screen. These data values are commonly referred to as pixels.

In the past, PC computer operating systems supported only rectangular windows. The Windows® 95 Operating System from Microsoft supports “region windows, “which can be non-rectangular in shape. A non-rectangular region is described and placed onto the window using SetWindowRgn API function, this means that all input from the user to window and any repainting that the window does is “clipped” to the window's region.

In addition to the SetWindowsRgn API, the Windows® NT 2000 and Windows® XP Operating Systems support “layered windows,” which allow much the same effect as SetWindowRgn, but accomplish the effect in a more efficient way. If a regional window changes its shape frequently or is dragged on the screen, the operating system will have to ask windows beneath the regional window to repaint. The calculations that occur when Windows tries to figure out invalid regions or visible regions become increasingly expensive when a window has an associated region. Use of layered windows with the SetLayeredWindowAttributes API function or UpdateLayeredWindow API function allows the window to define a color-key. Pixels which are the same value as the color-key are transparent both visually and to mouse events of the windows user interface. Proper use of the layering functions and associated window painting, give the exact same effect as setting the window region.

Previous attempts to show live or recorded “chroma-key” style video presentation on the computer graphical user interface, such as described in U.S. Pat. No. 6,288,753 to DeNicola, have had a number of shortcomings. These generally known attempts require special circuitry to be embedded into the computer equipment, such as a Chroma-key video mixer, to combine two or more video signals into a single video stream for broadcasting. Thereby, an instructor may be superimposed upon a graphic display. However, these generally known chroma-key style video presentations require that both the foreground image and the background image be combined prior to transmission. Consequently, the foreground video image may not be transmitted independent of the window environment that is currently present on the receiving user interface.

Some simple arbitrary shaped animation has been done on the “desktop” of the graphical user interface, such as described in U.S. Pat. No. 6,121,981 to Trower (2000). Animation is regioned by requiring that each frame use a specific background color. This color is then used as a 100% alpha channel for the window animation. Thus regioning is a straightforward process of locating pixels with a specific color value. By contrast, when sampling from streaming video, the background, which was originally in the raw uncompressed video a specific color value, changes to a variety of similar colors. These color changes are commonly known as video compression artifacts. This is because almost every video streaming codec is based on a lossy algorithm, in which information about the picture is lost for the sake of file size. Thus, this reference requires that any compression algorithm must be lossless, increasing the required bandwidth and limiting the available animation sources suitable for regioning.

Consequently, a significant need exists for a dynamically forming a corresponding region around a foreground video image that may be superimposed upon a windowed user interface.

### BRIEF SUMMARY OF THE INVENTION

The invention provides a method and system for generating arbitrary shaped video presentation in a user interface of a computer from a recorded or live video streaming source. The foreground video image may then be superimposed upon a user interface on a recipient's computer without regard to what background images are currently displayed. By so doing, an increased range of more dynamic and entertaining presentations of visual and audio are possible. The sources of the video image are expanded beyond mere animation that has a specific background color value. Instead, real-time imaging may be used of human actors. In addition, the transmission of the video image may utilize lossy algorithms with their advantageous reductions in transmission bandwidth.

In one aspect of the invention, a method, apparatus and program product are provided for presenting a compositing an arbitrarily shaped foreground portion of the video signal onto a user interface. A video frame having a plurality of pixels is received. A chroma-key operation is performed on the video frame, comparing the plurality of pixels to a variance threshold to determine a foreground region of the video frame. A region window is set on the user interface corresponding to the foreground region. Then a portion of the video frame corresponding to the region window is displayed on the user interface. Thereby, an independent image may be superimposed upon other graphical content in an independent fashion.

By virtue of the foregoing, a content provider may advantageously distribute graphical content such as a weather radar map to users. Associated with the graphical content, a real-time, or near-real time video image of an object or actor may be also be sent in a streaming video signal to elaborate and explain what is presented in the graphical content. Superimposing only the foreground portion of the video image allows for the video to avoid obliterating underlying graphical information. Moreover, allowing the video to seemingly move independent of any window accentuates the impact of the image.

These and other objects and advantages of the present invention shall be made apparent from the accompanying drawings and the description thereof.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a diagram of a computer network wherein a video signal is FIG. 1A is a general block diagram of a computer that serves as an operating environment for the invention.

FIG. 2 is a screen shot illustrating an example of video of a live actor being superimposed over the top of the user interface in windowing environment.

FIG. 3 is a flow diagram illustrating how the system displays video by setting the video display window region with regions created from captured sample frames.

FIG. 4 is a flow diagram illustrating how the system displays video by setting the video display window region with regions that are calculated ahead of time and embedded in the streaming media.

FIG. 5 is a flow diagram illustrating how the system displays video by setting the windows transparency key-color and modifying the captured sample frames with a mask created from the key-color, sample frames and color-matching algorithm.

FIG. 6 is a flow diagram illustrating how the system displays video by setting the windows transparency key-color and modifying the captured sample frames with a mask that has been calculated ahead of time and embedded in the streaming media.

### DETAILED DESCRIPTION OF THE INVENTION

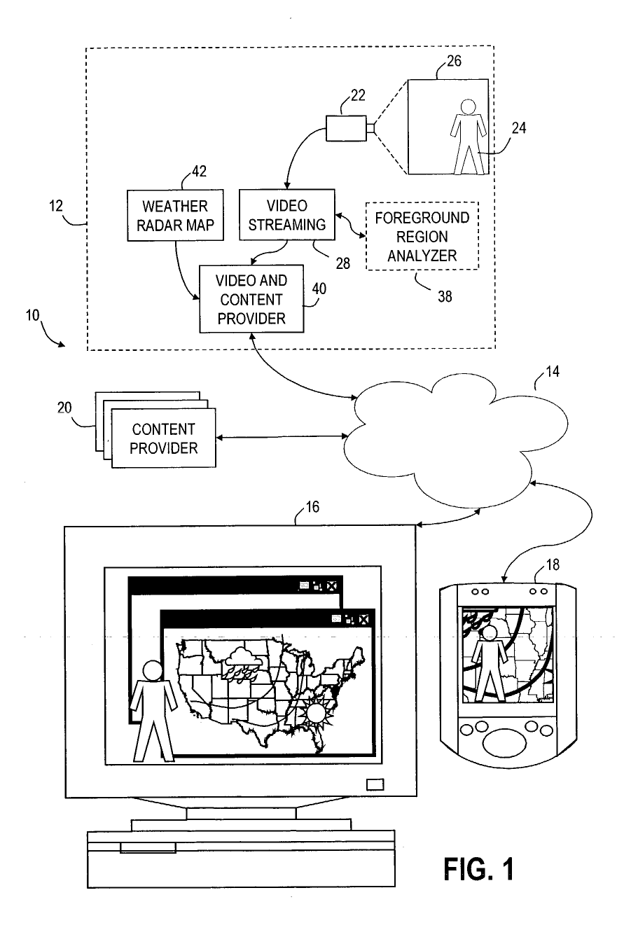

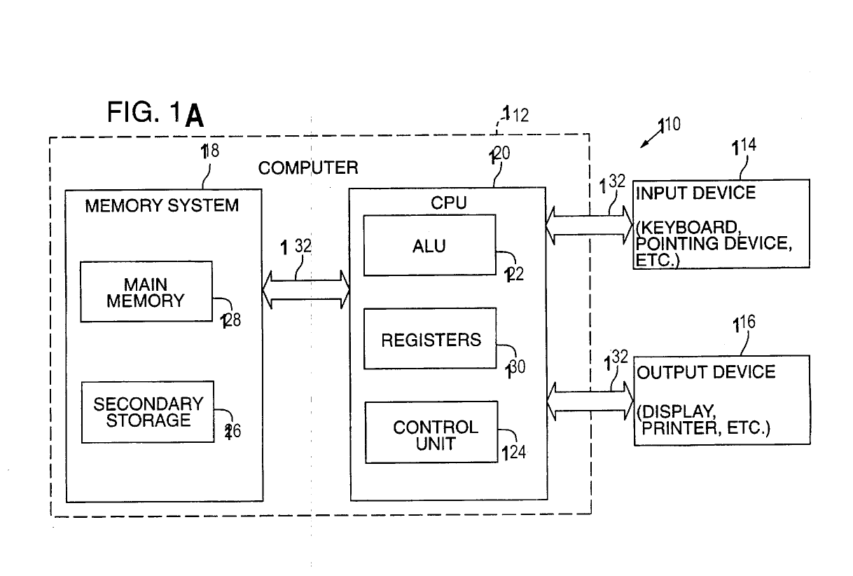

Turning to the Drawings, wherein like numerals denote like components throughout the several views, FIG. 1 depicts a computer network 10 that includes a video and graphical system 12 that distributes a streaming video signal and other digital content across a network 14 (e.g., Internet, intranet, telephone system, wireless ad hoc network, combinations thereof, etc.) to user computers 16, 18. The user computers 16, 18 may simultaneously be interacting with other content providers 20 across the network 14, or be viewing locally generated content. The user computer 16 illustrates a high-end device capable of operating a number of applications simultaneously with a higher resolution display than an illustrative hand-held device, depicted as user computer 18. In both instances, the users are able to enjoy a video depiction of an actor that seemingly is independent of other windowed applications displayed on the user computers 16, 18. Moreover, the actor 24 may advantageously be superimposed in a coordinated fashion with other content.

The video and graphical system 12 in the illustrative embodiment includes a digital video camera 22 that captures a scene including an actor 24 before a generally monochromatic background 26 (e.g., blue screen, green screen, etc.). In some instances, the video signal is compressed by a video streaming device 28, although it will be appreciated that some applications have sufficient throughput capacity not to require this step. The video streaming device 28 is not limited to lossless techniques wherein the original image may be recovered, but instead may include devices that further vary the hue of the background 26.

Advantageously, the video and graphic system 12 may perform operations upon the video signal to simplify detection of the foreground portion (e.g., actor 24), such as for a low-end user computer 18. A foreground region analyzer 38 may detect the foreground region (e.g., actor 24) as described in more detail below and send data with, or encoded into, the streaming video signal, via a video and content provider device 40, such as a server coupled to the network 14.

In the illustrative embodiment, the video and graphic system 12 distributes other graphical content, depicted as a weather radar map 42. This illustrates further advantages of the present invention. The video image is not superimposed upon this graphical content at the source, and thus the foreground portion (e.g., actor 24) may be placed in a strategic position when rendered at the user computer 16, 18 to accentuate without obliterating the graphical content 42. Moreover, the user computer 16, 18 may even opt to reposition or close the foreground portion of the video image.

It will be appreciated that the robust capability of the invention described herein tolerates a degree of nonuniformity in the monochrome background 26 and variation in hues in the background introduced by lighting, digital camera sampling, compression etc. This situation thus differs substantially from animation signals that can readily be produced with a single chromatic key background.

FIG. 1A is a general block diagram of a computer system 110, such as computers 12, 16, 18 of FIG. 1, that serves as an operating environment for the invention. The computer system 110 includes as its basic elements a computer 112, on or more input devices 114, including a keyboard and a cursor control device (e.g., pointing device), and one or more output devices 116, including a display monitor.

The computer 112 has a memory system 118 and at least one high speed processing unit (CPU) 120. The input and output device, memory system and CPU are interconnected and communicate through at lease on bus structure 132.

The CPU 120 has a conventional design and includes an Arithmetic Logic Unit (ALU) 122 for performing computations, a collection of registers 130 for temporary storage of data and instructions, and a control unit 124 for controlling operation of the system 110. The CPU 120 may be a processor having any of a variety of architectures include Alpha from Digital, MIPS from MIPS Technology, NEC, IDT, Siemens, and others, x 68 from Intel and others, including Cyrix, AMD, and Nexgen, and the PowerPc from IBM and Motorola.

The memory system 118 generally includes high-speed main memory 128 in the form of a medium such as random access memory (RAM) and read only memory (ROM) semiconductor devices, and secondary storage 126 in the form of long term storage mediums such as floppy disks, hard disks, tape, CD-ROM, DVD-ROM, flash memory, etc. and other devices that store data using electrical, magnetic, optical or other recording media. The main memory 128 also can include video display memory for displaying images through a display device. The memory 118 can comprise a variety of alternative components having a variety of storage capacities.

The input and output devices 114, 116 are conventional peripheral devices coupled to or installed within the computer. The input device 114 can comprise a keyboard, a cursor control devices such as a mouse or trackball, a physical transducer (e.g. a microphone), etc. The output device 116 shows in FIG. 1A generally represents a variety of conventional output devices typically provided with a computer systems such as a display monitor, a printer, a transducer (e.g. a set of speakers), etc. Since the invention relates to computer hosted video display, a computer must have some form of a display monitor for displaying the video.

For some devices, the input and output devices actually reside within a single peripheral. Such devices, such as a network interface or a modem, operate as input and output devices.

It should be understood that FIG. 1A is a block diagram illustrating the basic elements of a computer system; the figure is not intended to illustrate a specific architecture for a computer system 110. For example, no particular bus structure is shown because various bus structures known in the field of computer design may be used to interconnect the elements of the computer system in a number of ways, as desired. CPU 120 may be comprised of discrete ALU 122, registers 130 and control unit 124 or may be a single device in which on or more of these parts of the CPU are integrated together, such as in a microprocessor. Moreover, the number and arrangement of elements of the computer system may be varied from what is shown and described in ways known in the computer industry.

### Video Presentation System Overview

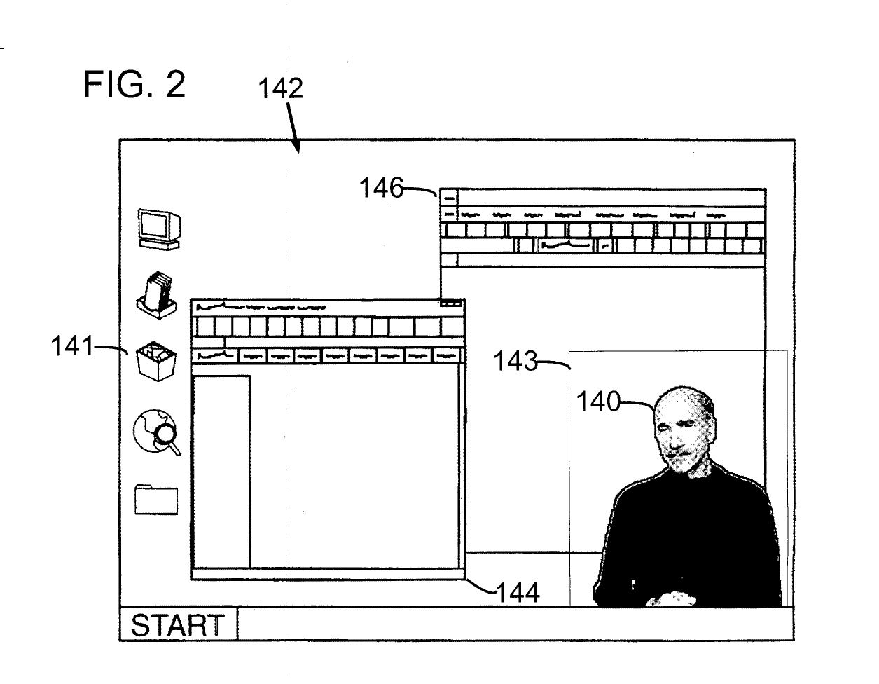

FIG. 2 is a screen shot illustrating an example of color-keyed video stream (“video”) 140 located on top of (in the foreground of) a user interface 141 in a windowing environment. This screen shot illustrates one example of how an implementation of the invention created arbitrary shaped video display that is not confined to the window of a hosting application or the window of an application requesting playback of the video. The video 140 can move anywhere in the user interface. Thus, a received video display window 143 may be selectively sized and positioned on the user interface 141 with only a foreground component displayed as at 140 with the remaining portion rendered transparent.

In this windowing environment, the user interface 141, referred to as the “desktop,” includes a shell 142 of the operating system as well as a couple of windows 144, 146 associated with currently running application programs.

Specifically, this example includes an Internet browser application in one window 144 and a word processor application 146 running in a second window on the desktop of the operating system. A client program, such as a script running in the process space of the browser, can request playback of the video that plays outside the boundaries of the browser window 144. Similarly, a client program such as a word processing program can request playback of a video that plays outside the boundaries of its window (e.g. window 146 in FIG. 2).

The video 140 moves in the foreground of the “desktop” 141 and each of the windows 144, 146 of the executing applications. As the video moves about the screen, a video system computes the bounding region of the non-transparent portion of the video and generates a new window with the shape to match this bounding region. This gives the appearance that the video display is independent from the user interface and each of the windows.

The bounding region defines the area occupied by non-transparent pixels within a frame of the full video image. This bounding region defines the foreground components that are nontransparent from the background components that rendered transparent, whether the foreground components are a contiguous group of pixels or disjointed groups of contiguous pixels. For example, if the video image were in the shape of a red doughnut with a key-colored center, the bounding region would define the red pixels of the doughnut as groups of contiguous pixels that comprise the doughnut, excluding the transparent center. The bounding region is capable of defining non-rectangular shaped windows include one or more transparent holes and including more than one disjointed group of pixels.

A challenge overcome by the present invention is determining what pixels from each frame of video should be transparent in order to dynamically region the window. Generally known approaches require that the painting of the background of each frame have a very specific color value. This color is then used as a 100% alpha channel for the window animation. In the inventive approach, a robust background determination is performed to mitigate problems associated with real-world video images having variations in the background, either due to the original scene or errors introduced during transmission. When sampling from streaming video, the background, which was originally in the raw uncompressed video a specific color value, changes to a variety of similar colors. These color changes are commonly known as video compression artifacts. This is because almost every video streaming codec is based on a lossy algorithm, in which information about the picture is lost for the sake of file size. By contrast, generally known approaches require that the background be uniform and that any compression algorithm used must be lossless.

Determining which pixels from each image that should be transparent can be done in one of several ways. In the illustrative embodiment, a transparent color is selected (e.g., Red-Green-Blue or RGB value [0, 0, 255] for solid blue), and a tolerance is selected (e.g., 20). By using Pythagorean theorem, and imagining the RGB values as coordinates in three-dimensional space, the distance that each pixel is from the chosen transparent color is determined and thresholded. For example, for a Pixel having an RGB value of [10, 10, 255] and a selected transparent color having an RGB value [0, 0, 255], the tolerance is 20.

It will be appreciated that other techniques than RGB calculations may be used. For instance, similar techniques in other color spaces such as Luminance-Bandwidth-Chrominance (i.e., “YUV”) or Hue Saturation Value (i.e., “HSV”) may result in even better color matching, although such similar techniques tend to increase processing to convert color spaces in the allowed time between frames of the streaming video. U.S. Pat. No. 5,355,174 to Mishima, which is hereby incorporated by reference, discloses an approach to chroma-key generation.

An advantage of our technique is that the background can also be “dirty” in the streaming video, meaning the actual physical background used behind the object or person being filmed can be less than perfectly lit or have physical imperfections. The video compression codec smoothes out these small imperfections by loosing this high frequency data and our algorithm for color matching then identifies the dirty area as being similar enough to the transparent color as to be considered transparent.

Once computed, the bounding region can be used to set a region window, a non-rectangular window capable of clipping input and output to the non-transparent pixels defined by the bounding region. Region windows can be implemented as a module of the operating system or as a module outside the operating systems. Preferably, the software module implementing the region windows should have access to input events from the keyboard and cursor positioning device and to the other programs using the display screen so that it clip the input and output to the bounding region for each frame. The Windows® Operating System supports the clipping of input and output to region windows as explained below.

The method outlined about for drawing non-rectangular frames of a video stream can be implemented in a variety of different types of computer systems. Though four implementations are described below, the basic principles of the invention can be applied to different software architectures as well.

The operating system of the first and second described implementation is the Windows® 95 operating system from Microsoft Corporation. The application program interface for the operating system includes two functions used to create and control region windows. These functions are SetWindowRgn and GetWindowRgn.

The SetWindowRgn function sets the window region of a rectangular host window. In this particular implementation, the window region is an arbitrary shaped region on the display screen defined by an array of rectangles. These rectangles describe the rectangular region of pixels in the host window that the window region covers.

The window region determines the area within the host window where the operating system permits drawing. The operating system does not display any portion of the window that lies outside the window region.

The GetWindowRgn function obtains a copy of the window region of a window. Calling the SetWindowRgn function sets the window region of a window.

The operating system of the third and four described implementation is the Windows® NT 2000 operating system from Microsoft Corporation. The application program interfaces for the operating system includes two functions to set the transparency key-color of a layered window. These functions are SetLayeredWindowAttributes and UpdateLayeredWindow.

The SetLayeredWindowAttributes function sets the opacity and transparency color key of a layered window. The UpdateLayeredWindow function updates the position, size, shape, content, and translucency of a layered window.

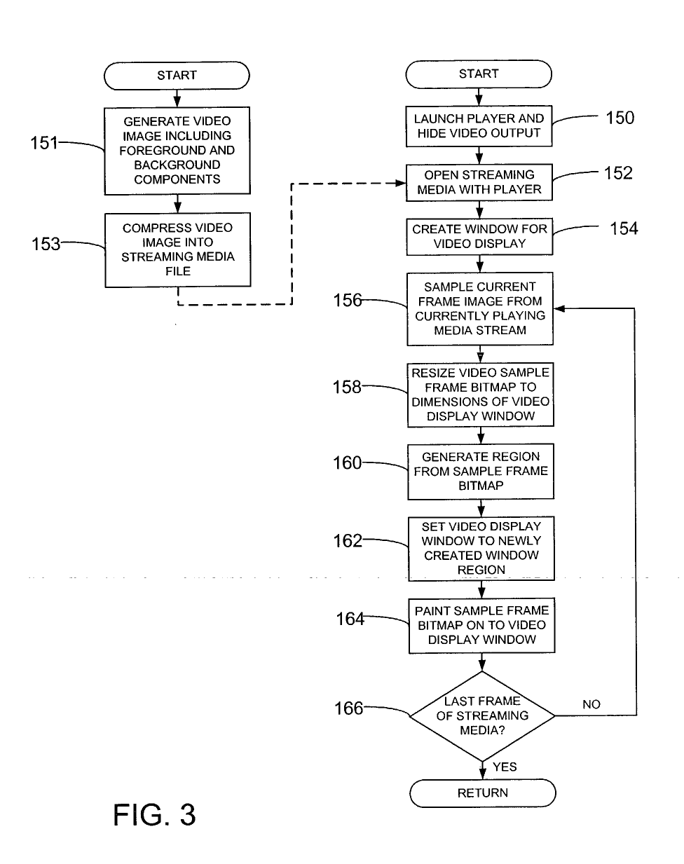

FIG. 3 is a flow diagram illustrating how the system plays the video presentation. First an appropriate streaming video player is launched as shown in block 50, although the video output is hidden at this point. The launched player is then used to open a file containing streaming media (block 152). An appropriate streaming video player is any player application that can read, correctly uncompress the requested file and allow a frame to be sampled from the video stream as it is played. Block 152 starts the file playing, though no images are actually shown to the user interface. By allowing the player to render the images, yet not display them on the interface, synchronization of the audio soundtrack and any other necessary events are maintained.

The file can be located in local storage 126, 128 or can be located outside the computer 112 and accessed via a local area network or wide area network, such as the Internet. In the illustrative example, a transmitting entity creates a video image containing both a foreground component and a background component (block 151) and then compresses this signal for routing over a digital data network (block 153) to the receiving entity that renders both the video image and other digital graphical data for presentation.

Returning to the receiving entity, a window for video display is created in block 154, which may be a default size such as the size of the user interface. The window is initially fully transparent.

FIG. 3. continues to block 156, wherein a single frame is sampled from the video stream. Once a single frame has been sampled, this bitmap image is stretched and resized to match the dimensions of the video presentation window 140 (shown in FIG. 2) and then passed to the region generation function. This function generates a region based on the sample frame dimension, the color-key and any other parameters that further described colors that are similar to the color-key and may also be determined to be transparent.

The determination of what colors to be considered invisible can be computed using many different algorithms as discussed above, this illustrative implementation scans through the frame bitmap and uses an allowed variance of the red, green, blue (RGB) values that make up a pixel in comparison to the key-color. Those skilled in the art having the benefit of the present disclosure would be able to select algorithms for determining if a pixel should be considered to be visible or transparent. Simply looking for pixels that are equal to the key-color will not be satisfactory, in that the background may be “dirty” (not a solid color) during filming of the video due to debris in the background or subject lighting issues, or the background may have several shades of the key-color due to artifacts (minor visual changes from the original video) created by the compression algorithm used on the streaming video for transport or storage.

Once the region generator has created the region in block 160, the region of the display window is set in block 162 and the captured frame is painted onto the video presentation window 164. The system then goes back to block 156, requesting another sampled frame for the video stream. Since the video player has been playing the stream, and the creation of the region from the previously captured frame may have taken a relatively signification amount of time, several frames may be skipped and not displayed by the video presentation window. This is possible loss on slower computer systems is acceptable so that the audio track of the streaming media may be kept in synchronization with the currently displayed video frame.

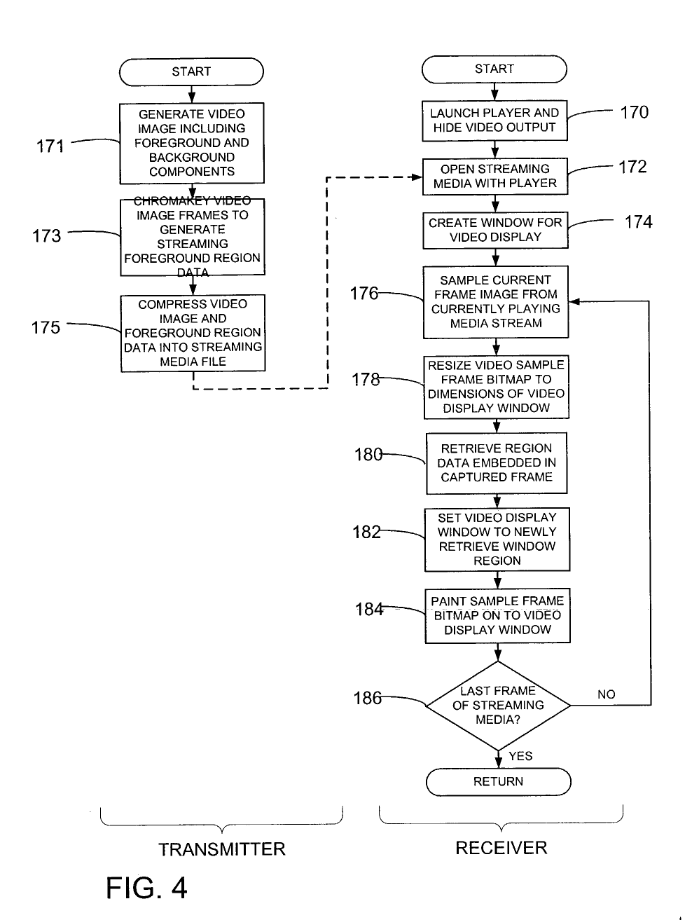

FIG. 4 describes a second implementation wherein the determination of foreground and background regions in the video signal is performed by the transmitting entity rather than by the receiving entity. Thus, data describing region windows is associated with the streaming video for accessing by the receiving entity, which may advantageously enhance the ability of low-end devices to present the composited video foreground over graphical content. While the second implementation reduces the computational requirements of the system, the bandwidth and/or file size need must be increased in order to transfer and/or store the pre-calculated regional data.

In particular, the transmitting entity generates a video image including foreground and background components (block 171), the video image frames are chroma-key analyzed to generate streaming foreground region data (block 173). The transmitting entity then distributes a compressed video image and the associated foreground region data as a streaming media file (block 175).

The receiving entity launches the media player and hides the video output (block 170). The streaming media file is opened with the player (block 172). The video display window for the video image is created, although hidden from the user at this point (block 174). The current video frame is sampled from the currently playing media stream (block 176). The video sample is sized to fit the frame bitmap dimensions of the video display window (block 178). The receiving entity then retrieves the data associated with the streaming media signal that describes the region of the foreground portion. The data may advantageously be embedded into the compressed streaming media signal (block 180). The video display window is then set to the newly retrieved window region, which then omits the background portions of the video signal (block 182). With the region window set, the sample frame bitmaps are painted to the video display window, with background pixels thus omitted as being in regions omitted in the display window (block 184). Unless this is the last frame of streaming media (block 186), then the process repeats back to block 176.

It will be appreciated that in some instances several more frames will have been displayed upon the same video display window before another sample frame is analyzed. This may allow either or both of the transmitting and receiving entities to perform less operations on the video image and to burden the display system of the user computer less with resizing the display window. Leaving the display window the same size is often sufficient given limitations of the user to detect changes frame to frame and limitations in typical video signals wherein the actor moves relatively small amounts frame to frame.

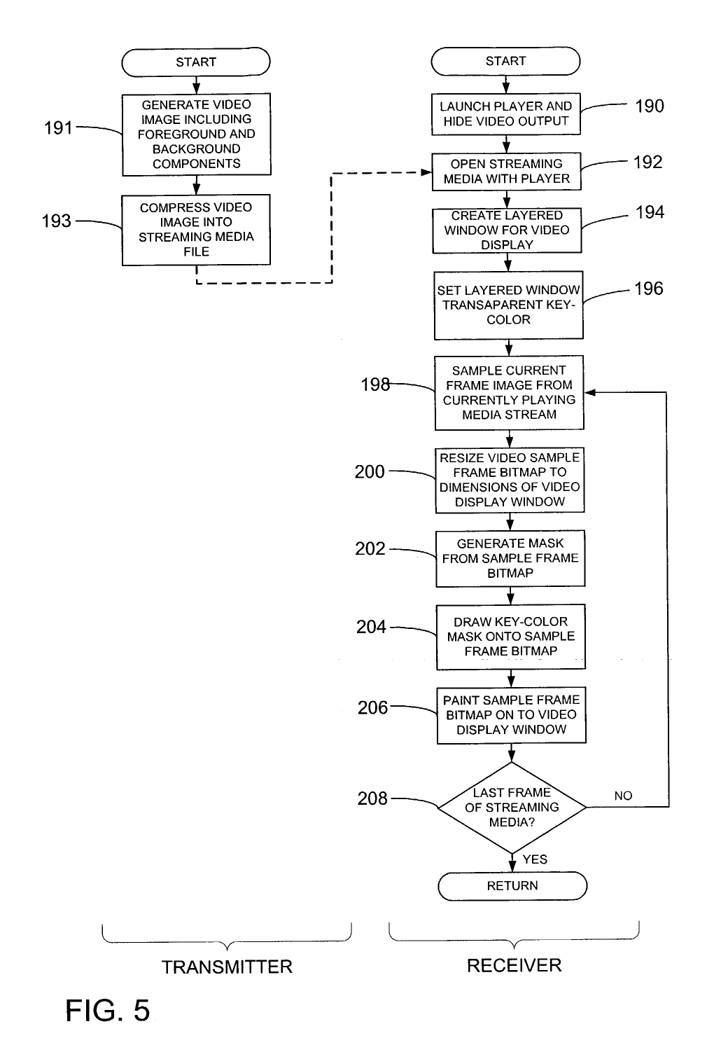

The third described implementation, depicted in FIG. 5, is similar to the first implementation in the way that video media is accessed, played and sample frames are captured. Specifically, blocks 190-193, 206-208 of FIG. 5 correspond to blocks 150-153, 164-166 described for FIG. 3. A difference arises in blocks 194-204 to address the manner in which Windows 2000 varies the shape of a window. Thus, a layered window is created for the video display in block 194.

When the video display window is created, the SetLayeredWindowAttributes API function is set to allow the operating system to make the key-color transparent for the window 196. The current frame from the streaming media that is playing is sampled (block 198). The video sample frame bitmap is resized to the dimension of the video display window (block 200). A mask is generated from the sample frame bitmap (block 202). Under this implementation instead of creating a region from the captured frame, the frame is modified so that the all pixels that are determined to be transparent are set to the key-color, creating a key-color mask (block 204). The frame is then painted to the video display window and the operating system takes care of the necessary operations to make the key-color transparent (block 206).

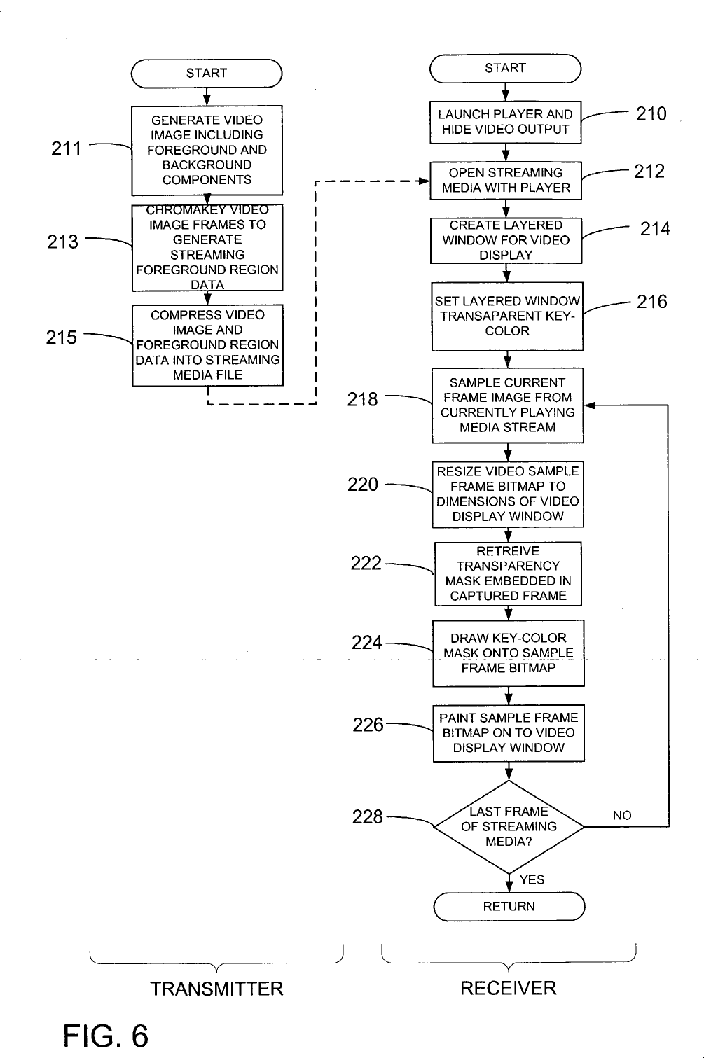

The fourth described implementation, described in FIG. 6, is similar to the second implementation of FIG. 4 in that the region window is determined by the transmitting entity and similar to the third implementation of FIG. 5 in the manner in which the region window is set in Windows 2000. This implementation lowers the CPU requirements for determining which pixels should be changed to the key-color, but as in the second implementation increases file size and bandwidth requirements.

The receiving entity launches the media player and hides the video output (block 210). The streaming media file is opened with the player (block 212). The layered video display window for the video image is created, although hidden from the user at this point (block 214). When the video display window is created, the SetLayeredWindowAttributes API function is set to allow the operating system to make the key-color transparent for the window (block 216). The video sample is sized to fit the frame bitmap dimensions of the video display window (block 218). The receiving entity then retrieves the data associated with the streaming media signal that describes the region of the foreground portion. The data may advantageously be embedded into the compressed streaming media signal (block 220). The receiving entity then retrieves the data associated with the streaming media signal that describes the region of the foreground portion. The data may advantageously be embedded into the compressed streaming media signal (block 222). The key-color mask is drawn onto the sample frame bitmap (block 224). Then, the sample frame bitmap is painted onto the layeredvideo display window (block 226). Unless this is the last frame of streaming media (block 228), then the process repeats back to block 218.

In view of the many possible embodiments to which the principles of our invention may be applied, it should be recognized that the implementations described above are only examples of the invention and should not be taken as a limitation on the scope of the invention.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

For example, the term “video” is used herein to denote a sequence of digital color images. Various formats and technologies for capturing and transmitting video images may be employed, such as but not limited to NTSC, PAL, and HDTV. These images may comprise color or gray scale images and may or may not include an audio track. In addition, although the illustrative example includes an image of a human actor as the foreground video image, it will be appreciated that a wide range of images having a foreground and background component would be applicable. Moreover, aspects of the present invention are applicable to analog video signals, such as when the foreground video image originates as an analog video signal, is transmitted as an analog video signal, and/or is displayed upon an analog display (e.g., TV screen).

What is claimed is:

1. A method for compositing an arbitrarily shaped foreground portion of the video signal onto a user interface, comprising:
receiving a video frame having a plurality of pixels;
performing a chroma-key operation on the video frame, comparing the plurality of pixels to a variance threshold to determine a foreground region of the video frame;
setting a region window on the user interface corresponding to the foreground region;
displaying a portion of the video frame corresponding to the region window.

2. The method of claim 1, further comprising:
compressing the video frame into a streaming video signal;
transmitting the streaming video signal and data describing the foreground region;
receiving the video signal;
decompressing the streaming video signal, wherein setting the region window is performed in reference to received data.

3. The method of claim 1, wherein setting the region window on the user interface corresponding to the foreground region and displaying the portion of the video frame corresponding to the region window, further comprises:
drawing a key-color mask onto the video frame; and
painting the resulting video frame onto a layered video display window on the user interface.

4. The method of claim 1, further comprising:
receiving a graphical image associated with the video frame;
rendering the graphical image in a window on the user interface; and
setting the region window at least partially superimposed upon the graphical image window.

5. The method of claim 4, further comprising:
generating a meteorological depiction as the graphical image;
generating a sequence of video frames of an actor describing the meteorological depiction; and
transmitting the graphical image and video frames to the user interface.
